(19) United States
(12) Patent Application Publication
(10) Pub. No.: US 2016/0080554 A1
(43) Pub. Date: Mar. 17, 2016

(54) AUDIOVISUAL NAVIGATION SYSTEM AND METHOD

(71) Applicant: 10PSY, LLC, San Francisco, CA (US)

(72) Inventor: Masahiko Shimodaira, San Francisco, CA (US)

(21) Appl. No.: 14/487,069

(22) Filed: Sep. 15, 2014

(51) Int. Cl. H04M 1/725; H04W 4/02

(52) U.S. Cl. CPC H04M 1/72572; H04W 4/02

(57) ABSTRACT

An audiovisual navigation system and method displays a geographical site in the form of audiovisual data to create an interactive, visually enhanced navigational tool useful for receiving graphical directions and suggestions while traveling. The geographical site can be a position, starting point, destination point, and route that is located by a positioning system. Each geographical site correlates to a unique audiovisual data that is stored in a database. For example, each street has its own video, and each building has its own set of images that display at the appropriate time. The audiovisual data includes an interactive combination of audio signals, videos, and images. The audiovisual data synchronizes with a positioning system, such that the audiovisual data changes as the located geographical site changes. The system can be monetized by enabling members in a network to share and contribute audiovisual data for a geographic site, business, or route.

### FIELD OF THE INVENTION

The present invention relates generally to an audiovisual navigation system and method that displays unique audiovisual data at a corresponding geographical site. More so, the audiovisual navigation system and method displays a geographical site in the form of audio signals, videos, and images to create an interactive, visually enhanced navigational tool for providing graphical directions, fun facts, activities, and suggestions while navigating a route.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon.

By way of educational background, another aspect of the prior art generally useful to be aware of is that the ability to monitor and track movements of persons over geographic areas by use of monitoring devices is achieved through positioning systems, such as a global positioning system (GPS). GPS is a position/navigation system that consists of a constellation of twenty-eight satellites. A GPS receiver is an electronic device that receives signals from the satellites to determine its location on earth, in any weather. The GPS receivers at precisely known reference locations can provide corrections and relative positioning data for receivers at other locations.

It is known that most portable GPS receivers on the market today are designed for navigation, giving the user's position in terms of latitude and longitude or bearing and distance from a known point. Although a GPS moving map is effective for displaying the immediate position of an object, additional information about the route and the final destination within a proximal region of the object is often lacking.

Often, travelers needs information about the place they are visiting. However, each traveler may have different needs and interests. Some travelers need commercial information, others may wish to buy a product, some travelers like to know the history of a place, or to discover hidden corners, while others are simply bored and long for their journey to be made more interesting.

In many instances, talking books using CD-ROM disks may provide the information lacking in the above mentioned navigation systems, however as the location of the traveler is not monitored automatically, any information must be extracted manually by the traveler, which can be laborious. It is known that portable computers and pen computing systems provide essentially text based information on the move. However, neither offer user friendly, hands-free, eyes-free operation with automatic, dynamically retrieved audio or video data based on the traveler's position, altitude, attitude, speed, time, direction of view, stated needs and interests. Furthermore, it is not easy to use such a portable PC when walking or riding on horseback.

Even though the above cited systems and methods for navigational systems address some of the needs of the market, an audiovisual navigation system and method that displays unique audiovisual data at a corresponding geographical site, while enabling members in a network to contribute the audiovisual data is still desired.

### SUMMARY OF THE INVENTION

The present invention is directed to an audiovisual navigation system and method that displays a geographical site in the form of audio signals, videos, and images to create an interactive, visually enhanced navigational tool for providing graphical directions, fun facts, activities, and suggestions while navigating a route. In some embodiments, the audiovisual navigation system and method displays audiovisual data that correlates to a geographic site located by a positioning system. The system and method automatically retrieves the audiovisual data from a database when the respective geographical site is located, either by navigating the route or reaching a final destination. The audiovisual data may include, without limitation, an audio signal, a video, and an image of the geographical site.

In some embodiments, the audiovisual data can be developed by a mapping system before being stored on the database. However in other embodiments, at least one member of a network may contribute audiovisual data to the database, whereby members can access the audiovisual data depending on their position in the geographical site. In any case, the retrieved audiovisual data identifies, describes, and provides suggestive comments about the geographic site. The geographical site may be identified and described through visual and auditory displays in the form of a narrative as a location, an optimal route, a point of interest, navigational turn-by-turn directions, a virtual tour, and a map. The audiovisual data synchronizes with a positioning system, such that the audiovisual data changes as the located geographical site changes, i.e., the user moves from a starting point to a final destination. The system and method can be monetized by enabling members in a network to share and contribute audiovisual data for a geographic site, business, or route.

In one embodiment, the system and method synchronizes the position of a mobile device with a global positioning system (GPS) to locate the geographical site. A GPS receiver on the mobile device communicates with satellites on the GPS to attain a position and time information from which the geographical site can be derived. In one possible embodiment, a user can provide a starting point and a final destination to the GPS. The system and method may then display audiovisual data that correlates to the geographical site. The audiovisual data can include videos, audio, and images in the form of a location, optimal travel route, suggested sites of interest, fun facts, and activities along the route and at the final destination. In one embodiment, the audiovisual data can be a narrative in the form of a graphical depiction of the geographical site. This graphical depiction of the location creates a more realistic depiction of the location and facilitates the visualization of points of interest. In this manner, the system and method can automatically identify and describe places of specific interest, turn-by-turn directions, recommendations for commercial businesses, descriptions of landmarks and historical buildings, and reminders of prior navigated routes. In some embodiments, the positioning system provides location and time information on different scales of coverage, such that both an indoor region and an outdoor region can be located to display the appropriate audiovisual data.

In some embodiments, the system and method may be downloaded as a software application onto a smart phone. The software application coordinates with a GPS to display directions, suggested points of interest, and interesting facts about the geographical site in the form of audio, video, and images that display on the smart phone. In one embodiment, the visual display of the geographical site may utilize a swipe feature that enables the videos and graphics to be viewed on the smart phone by swiping the screen on the display, similar to leafs on a book. The swiping function facilitates viewing and access to the geographical site. In another embodiment, the software application integrates into a vehicle to provide audio turn-by-turn directions. The directions may include a human voice that provides directions in coordination with the GPS. In another embodiment, the turn-by-turn directions include menus and voice commands that enable hands-free and eye-free control while driving, flying, sailing or walking.

Additionally, the system provides a network for sharing comments, reviews, and route suggestions amongst at least one member. The network enables at least one member to contribute and/or receive at least a portion of the audiovisual data by any other member in a network. For example, the members may download reviews, comments, and recommendations between each other about the geographical sites. In one embodiment, the system and method comprises a network of P2P users that form a social network, in which users can review, and recommend both outdoor and indoor sites and routes thereto. This enables a more local source of information that users in the general proximity can share. From this information, a member of the network can choose to provide local, customized tours, and guidance to other members of the social network. In one embodiment, the system and method can monetize this by charging the member a fee for promoting a geographical site or route. In another embodiment, the members can all be charged a fee for joining the network. In yet another commercial embodiment, an advertiser can pay to have a short commercial played when a member is in proximity to a commercial geographical site or in proximity to a business.

A first aspect of the present invention provides an audiovisual navigation method for displaying audiovisual data that correlates to a geographic site, the method comprising:
providing a positioning system configured to locate a geographical site;
correlating an audiovisual data to the geographical site;
storing the audiovisual data;
contributing and/or receiving at least a portion of the audiovisual data by at least one member in a network;
locating the geographical site with the positioning system;
retrieving the audiovisual data that correlates to the correlating geographical site; and displaying the audiovisual data that correlates to the geographical site.

In a second aspect, the positioning system comprises a global positioning system.

In another aspect, the step of providing a positioning system, further comprises providing a positioning system receiver in a mobile device.

In another aspect, the mobile device comprises a smart phone.

In another aspect, the method comprises a step of downloading a software application on the mobile device, the software application configured to operate the method.

In another aspect, the audiovisual data comprises an audio signal, a video, and an image.

In another aspect, the step of storing an audiovisual data that correlates to a geographical site, further comprises storing the audiovisual data in a database.

In another aspect, the geographical site comprises an indoor region and/or an outdoor region.

In another aspect, the step of contributing and/or receiving at least a portion of the audiovisual data by at least one member in a network, further comprises the at least one member contributing at least a portion of the audiovisual data from a known geographical site.

In another aspect, the known geographical site is at least partially known by the at least one contributing member.

In another aspect, the step of contributing and/or receiving at least a portion of the audiovisual data by at least one member in a network, further comprises monetizing the contribution and reception of the audiovisual data by charging the at least one member for contributing or receiving the audiovisual data.

In another aspect, the network comprises a social website.

In another aspect, the step of locating the geographical site through the positioning system, further includes identifying a position and a time for the mobile device.

In another aspect, the step of displaying the audiovisual data, further comprises displaying the audiovisual data on a mobile device.

In another aspect, the audiovisual data is configured to display as a narrative.

In another aspect, the narrative comprises turn-by-turn directions, recommendations for commercial businesses, descriptions of landmarks and historical buildings, and reminders of prior navigated routes.

Yet another aspect of the present invention provides an audiovisual navigation system for displaying audiovisual data that correlates to a geographic site, the system comprising:
a positioning system configured to locate a geographical site of a positioning system receiver;
an audiovisual data configured to correlate to the geographical site,
the audiovisual data further configured to be stored in a database,
the audiovisual data comprising an audio signal, a video, and an image,
at least a portion of the audiovisual data contributed by at least one member in a network; and
a display device configured to retrieve the audiovisual data that correlates to the geographical site from the database,
the display device further configured to display the audiovisual data.

In another aspect, the system is configured to be downloaded on the display device as a software application.

In another aspect, the positioning system comprises a global positioning system.

In another aspect, the audiovisual data comprises an audio signal, a video, and an image.

In another aspect, the display device comprises a smart phone.

One objective of the present invention is to provide a navigational system that correlates a geographical site with an audio signal, video, and image.

Another objective is to create a visually enhanced navigational and informational description of a geographical site.

Another objective is to enable user friendly, hands-free, eyes-free operation with automatic, dynamically retrieved audio or video data based on a traveler's position, altitude, attitude, speed, time, direction of view, stated needs, and interests.

Another objective is to provide a database having audio signals, videos, and images of a plurality of geographical sites that correlates to geographical sites located by a positioning system.

Another objective is to provide navigational information, locations, optimal routes, points of interest, navigational turn-by-turn directions, virtual tours, and maps for both an outdoor region and an indoor region.

Yet another objective is to provide robust auditory turn-by-turn directions for a vehicle.

Yet another objective is to form a network of members through a social network site that can review and comment on the geographical sites.

Yet another objective is to monetize the social network site.

Yet another objective is to utilize preexisting positioning systems, such as a GPS, and synchronize the locations and time information from the GPS with audiovisual data in the database.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, in which:

FIG. 1 illustrates a block diagram of an exemplary an audiovisual navigation system, in accordance with an embodiment of the present invention;

FIG. 2 illustrates a flow chart diagram of an exemplary an audiovisual navigation method, in accordance with an embodiment of the present invention;

FIG. 3 illustrates a flow chart diagram of an exemplary an audiovisual navigation method operated through a software application, in accordance with an embodiment of the present invention;

FIG. 4 illustrates a flow chart diagram of an exemplary an audiovisual navigation method and an exemplary positioning system locating an indoor region and an outdoor region, in accordance with an embodiment of the present invention;

FIG. 5 illustrates a flow chart diagram of an exemplary navigation function of the audiovisual navigation method, in accordance with an embodiment of the present invention;

FIG. 6 illustrates a flow chart diagram of an exemplary an audiovisual navigation method displaying audiovisual data in the form of fun facts and trivial information about a geographical site, in accordance with an embodiment of the present invention;

FIG. 7 illustrates a flow chart diagram of an exemplary an audiovisual navigation method displaying audiovisual data in the form of activities for a geographical site, in accordance with an embodiment of the present invention; and

FIG. 8 illustrates a block diagram depicting an exemplary client/server system which may be used by an exemplary web-enabled/networked embodiment, in accordance with an embodiment of the present invention.

Like reference numerals refer to like parts throughout the various views of the drawings.

### DETAILED DESCRIPTION OF THE INVENTION

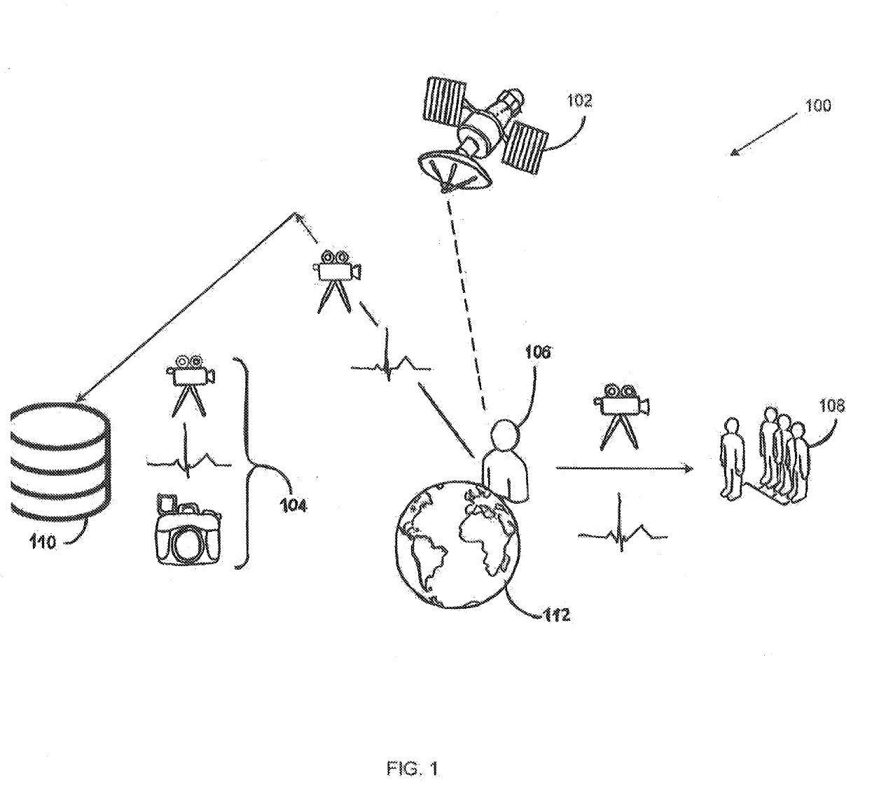

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention, presented in FIGS. 1-8, an audiovisual navigation system 100 and method 200 displays a geographical site 112 in the form of audiovisual data 104 to create an interactive, visually enhanced navigational tool useful for receiving graphical turn-by-turn directions, reviews, fun facts, activity recommendations, and route suggestions while navigating a route. The geographical site 112 may include a position of an object in terms of latitude and longitude or bearing and distance from a known point. In one embodiment, the geographic site 112 includes a starting point, destination point, and route that is located by a positioning system 102. Each geographical site 112 correlates to a unique audiovisual data 104 that is stored in a database 110. For example, each street has its own video, and each building has its own set of images that display at the appropriate time.

In some embodiments, the audiovisual data 104 can include an interactive combination of audio signals, videos, and images. The audiovisual data 104 synchronizes with a positioning system 102, such that the audiovisual data 104 changes as the located geographical site 112 changes, i.e., the user moves from a starting point to a final destination. In this manner, the system can provide a user friendly, hands-free, eyes-free operation with automatic, dynamically retrieved audio or video data based on a traveler's position, altitude, attitude, speed, time, direction of view, stated needs, and interests.

The system 100 and method 200 may also allow at least one member 106 of a network 108, such as a social website, to experience and share navigational directions, suggest sites of interest, and view comments and reviews between other members 106 in the network 108. The navigational system 100 and method 200 accumulates the audiovisual data 104 from the member 106 to be used for future presentations related to the respective geographic site 112. Thus, the audiovisual navigation system 100 and method 200 is effective in creating an interactive, and graphically enhanced navigational experience for at least one member 106 in a network 108, and in other embodiments, a user from the general public.

As referenced in FIG. 1, the audiovisual navigation system 100 is efficacious for displaying audiovisual data 104 that correlates to a geographic site 112 located by a positioning system 102. The system 100 automatically stores and retrieves the audiovisual data 104 from a database 110 or other data storage site, including, without limitation, a server, a cloud, an intranet, an internet, and a portable storage device. The audiovisual data 104 may include, without limitation, an audio signal, a video, and an image of the geographical site 112. For example, without limitation, an avatar speaks to a user traveling through a city. As the user passes a building, the avatar describes the historical significance of the building, including the display of charts, drawings, and maps of the interior of the building.

In some embodiments, the audiovisual data 104 can be developed by a mapping system before being stored on the database 110. However in other embodiments, at least one member 106 of a network 108 may contribute audiovisual data 104 to the database 110; whereby other members 106 in the network 108 can access the audiovisual data 104 depending on their position in the geographical site 112. In any case, the retrieved audiovisual data 104 identifies, describes, and provides suggestive comments about the geographic site 112. The geographical site 112 may be identified and described through visual and auditory displays in the form of a narrative as a location, an optimal route, a point of interest, navigational turn-by-turn directions, a virtual tour, and a map. The visual and auditory displays synchronize with the positioning system 102 in real time, so that the audio signal, video, and image constantly change in step with changes in the geographical site 112.

In one embodiment, the system 100 synchronizes the position of a mobile device with a global positioning system 102 (GPS) to locate the geographical site 112. A GPS receiver on the mobile device communicates with satellites on the GPS to attain a position and time information from which the geographical site 112 can be derived. A user can provide a starting point and a final destination to the positioning system 102. The system 100 may then display audiovisual data 104 that correlates to the geographical site 112 in the form of a location, optimal travel route, and suggested sites of interest. In one embodiment, the system 100 relays information, facts, and suggestions while in route to the final destination. In this manner, the system 100 can graphically and interactively identify and describe places of specific interest, turn-by-turn directions, recommendations for commercial businesses, descriptions of landmarks and historical buildings, and reminders of prior navigated routes.

In some embodiments, the positioning system 102 provides location and time information on different scales of coverage, such that both an indoor region and an outdoor region can be located to display the appropriate audiovisual data 104. In this manner, a roadway or an interior section of a building can be identified and described through the audio signal, video, and image. Examples of both indoor and outdoor regions of the geographical sites 112 may include, without limitation, hotels, hospitals, shops, museums, indoor shopping malls, outdoor shopping malls, and residential streets.

In some embodiments, the system 100 may be downloaded as a software application onto a smart phone. The software application coordinates with a GPS to display directions, suggested points of interest, and interesting facts about the geographical site 112 in the form of audio, video, and images that display on the smart phone. In one embodiment, the visual display of the geographical site 112 may utilize a swipe feature that enables the videos and graphics to be viewed on the smart phone by swiping the screen on the display, similar to flipping through the pages of a magazine. The swiping function facilitates viewing and access to the geographical site 112. In another embodiment, the software application integrates into a vehicle to provide audio turn-by-turn directions. The directions may include a human voice that provides directions in coordination with the GPS. In another embodiment, the turn-by-turn directions include menus and voice commands that enable hands-free and eye-free control while driving, flying, sailing or walking.

Additionally, the system 100 provides a network 108 for sharing comments, reviews, and route suggestions amongst at least one member 106. The network 108 enables at least one member 106 to contribute and/or receive at least a portion of the audiovisual data 104 by any other member 106 in a network 108. The network 108 may include, without limitation, a social website, an intranet network, a web based game, a global positioning system network, and a communication network. In one example, the members 106 may download reviews, comments, and recommendations between each other about the geographical site 112s. This audiovisual data 104 can be added to the database 110 and form a portion of the audiovisual data 104 that correlates to a geographical site 112. For example, without limitation, the at least one member 106 comments and captures a video of the Eiffel Tower in Paris. The system 100 stores the video in the database 110. When another member 106 is in proximity to the Eiffel Tower, the video is automatically retrieved and displayed, along with additional pertinent audiovisual data 104 for the Eiffel Tower.

In one embodiment, the system 100 comprises a network 108 of P2P users that form a social network 108, in which members 106 can review, and recommend both outdoor and indoor sites and routes thereto. This enables a more local source of information that members 106, or even the general public users, in the general proximity can share. From this information, at least one member 106 in the network 108 can choose to provide local, customized tours, and guidance to other members 106 of the network 108.

In one embodiment, the system 100 can monetize this by charging the member 106 a fee for promoting a geographical site 112 or route. In another embodiment, any of the members 106 can be charged a fee for joining the network 108. In yet another commercial embodiment, an advertiser can pay to have a short commercial played when a member 106 is in proximity to a commercial geographical site 112 or in proximity to a business. In one alternative embodiment, the system 100 may be used in a warehouse to receive comments and suggestions about products stored in the warehouse. In this embodiment, the positioning system 102 locates the user, and narrates which products are in the proximity, and the condition of the product. In yet another commercial embodiment, the system 100 may be used on a vacation tour of a jungle, theme park, or retail area; thereby replacing a tour guide.

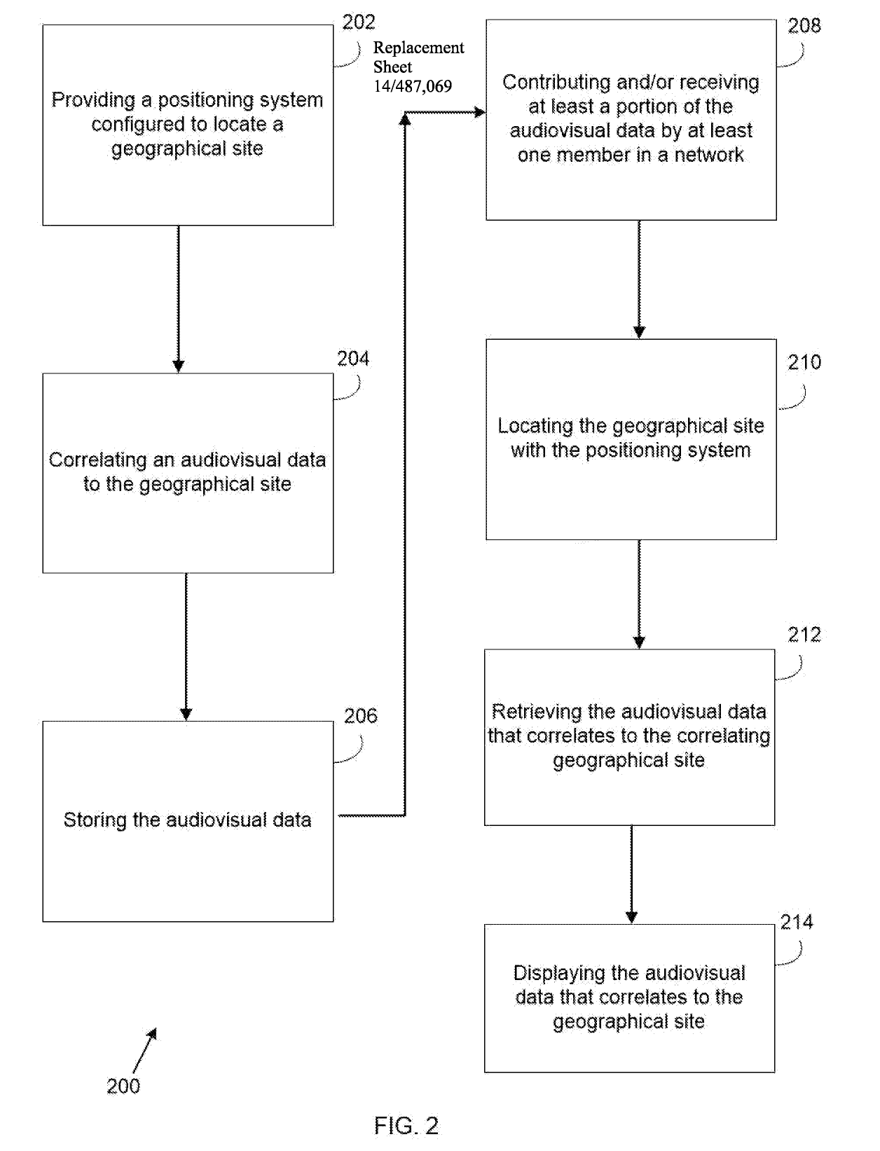

FIG. 2 illustrates a flowchart diagram of an exemplary audiovisual navigation method 200 for displaying audiovisual data 104 that correlates to a geographic site 112. In some embodiments, the method 200 displays audiovisual data 104 to identify, describe, and provide suggestive comments about the geographic site 112. The geographical site 112 includes a starting point, route, and final destination that is located by a positioning system 102, such as a GPS. The method 200 automatically retrieves the audiovisual data 104 that correlates with the geographic site from a database 110. The method 200 is also effective for enabling members 106 of a network 108 to contribute and retrieve audiovisual data 104 pertinent to the geographical site 112. The audiovisual data 104 shared between members 106 forms a portion of the total audiovisual data 104 stored in the database 110. This audiovisual data 104 may automatically, or selectively display for the appropriate geographic site 112. Additionally, the method 200 enables the monetization for selective display of the audiovisual data 104. The method 200 may include an initial Step 202 of providing a positioning system 102 configured to locate a geographical site 112. The positioning system 102 may include, without limitation, a GPS, a Global navigation satellite systems, and a tower system.

The method 200 may further comprise a Step 204 of correlating an audiovisual data 104 to the geographical site 112. The audiovisual data 104 may include, without limitation, an audio signal, a video, and an image of the geographical site 112. The audiovisual data 104 is stored in a database 110, such that when the geographical site 112 is located, the correlating audiovisual data 104 is retrieved and displayed. In one embodiment, the geographical site 112 may be identified and described through visual and auditory displays in the form of a narrative as a location, an optimal route, a point of interest, navigational turn-by-turn directions, a virtual tour, and a map. The visual and auditory displays synchronize with the positioning system 102 in real time, so that the audio signal, video, and image constantly change in step with changes in the geographical site 112. A Step 206 includes storing the audiovisual data 104. The audiovisual data 104 can be developed by a mapping system before being stored on the database 110. However in other embodiments, at least one member 106 of a network 108 may contribute audiovisual data 104 to the database 110; whereby members 106 can access the audiovisual data 104 depending on their position in the geographical site 112.

In some embodiments, a Step 208 comprises contributing and/or receiving at least a portion of the audiovisual data 104 by at least one member 106 in a network 108. The network 108 enables at least one member 106 of the network 108 to contribute and/or receive at least a portion of the audiovisual data 104 by at least one member 106. The network 108 may include, without limitation, a social website, an intranet network, a web based game, a global positioning system network, and a communication network. In one example, the members 106 may download reviews, comments, and recommendations between each other about the geographical sites 112. This audiovisual data 104 can be added to the database 110, forming a portion of the audiovisual data 104 that correlates to a geographical site 112. In one embodiment, Step 208 comprises the at least one member 106 contributing at least a portion of the audiovisual data 104 from a known geographical site 112. The known geographical site 112 can be a geographical site 112 that is at least partially known by the at least one contributing member 106. For example, a fishing hole that is off the main route.

In another embodiment, Step 208, further comprises monetizing the contribution and reception of the audiovisual data 104 by charging the at least one member 106 for contributing or receiving the audiovisual data 104. For example, the at least one member 106 who contributes or receives the audiovisual data 104 can be charged a fee for promoting a geographical site 112 or route. In another embodiment, the members 106 can all be charged a fee for joining the network 108. In yet another commercial embodiment, an advertiser can pay to have a short commercial played when a member 106 is in proximity to a commercial geographical site 112 or in proximity to a business. However, any commercial embodiment that integrates the positioning system 102 and the audiovisual data 104 into the network 108 or general public can be utilized to generate revenue.

In some embodiments, a Step 210 may include locating the geographical site 112 with the positioning system 102. The geographical site 112 may include, both an indoor region and an outdoor region. In one embodiment, a mobile device having a GPS receiver synchronizes with a GPS to locate the geographical site 112 of a user from a starting point, a route, and a destination point. The GPS receiver on the mobile device communicates with satellites on the GPS to attain a position and time information from which the geographical site 112 can be derived. In some embodiments, a Step 212 may include retrieving the audiovisual data 104 that correlates to the correlating geographical site 112. The audiovisual data 104 that is stored in the database 110 is automatically retrieved when the geographical site 112 is located by the positioning system 102. A final Step 214 comprises displaying the audiovisual data 104 that correlates to the geographical site 112. The audiovisual data 104 displays when the geographical site 112 is located by the positioning system 102. In one embodiment, the display comprises videos, images, and audio signals on a smart phone screen.

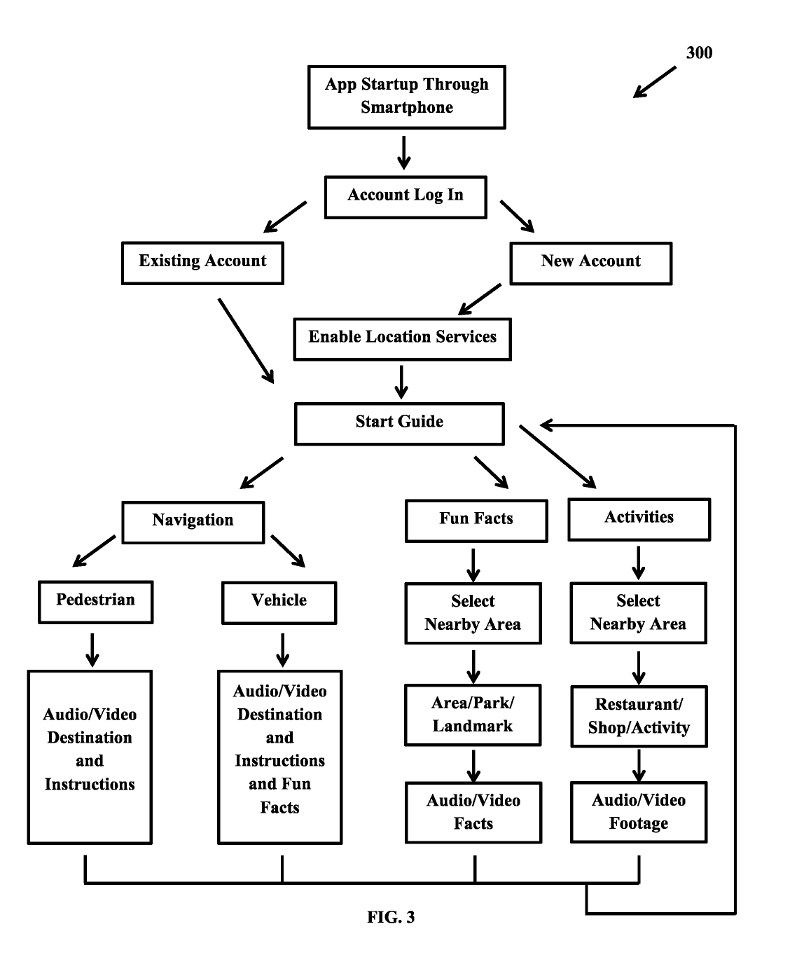

FIG. 3 illustrates a flow chart diagram of an exemplary an audiovisual navigation method 300 operated through a software application, in accordance with an embodiment of the present invention. In the present invention, the method 300 may be downloadable as a mobile app for a mobile device, such as a smart phone. The mobile app may include a computer program designed to run on smartphones, tablet computers, and other mobile devices. The mobile app may be free, or a fee can be charged. A member 106 of the network 108, or a general public user can log in as a new user or into an existing account. The locating services of the positioning system 102 may then be enabled to locate the geographical site 112 of the user. In some embodiments, a navigation function helps the user to better communicate the circumstances with the positioning system 102. For example, the user can be a pedestrian walking or a vehicle driving. Or if the user desires destination instructions, or fun facts about the destination, a fun facts function provides useful trivia about the geographic site that the user is at, or wishes to be at. An activities function communicates the different activities available in route to, or at the geographical site 112. These functions are relayed through the various formats provided by the audiovisual data 104.

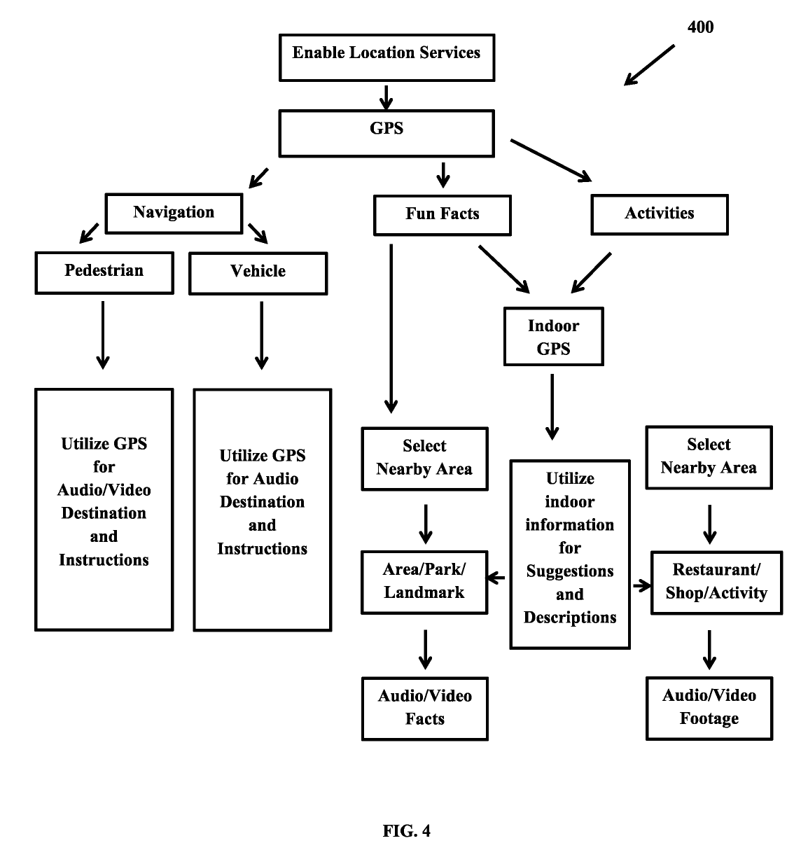

FIG. 4 illustrates a flow chart diagram of an exemplary an audiovisual navigation method 400 and an exemplary positioning system 102 locating an indoor region and an outdoor region, in accordance with an embodiment of the present invention. In the present invention, the positioning system 102 provides location and time information on different scales of coverage, such that both an indoor region and an outdoor region can be located to display the appropriate audiovisual data 104. In one embodiment, the locating capacity of the positioning system 102 may then be enabled to locate the geographical position of the user. The user can then select between the navigation function, the fun facts function, and the activities function. An indoor positioning system 102 utilizes indoor information for the fun fact function and the activity function. If an indoor region is selected, such as a landmark, the fun facts or activities can be retrieved and displayed.

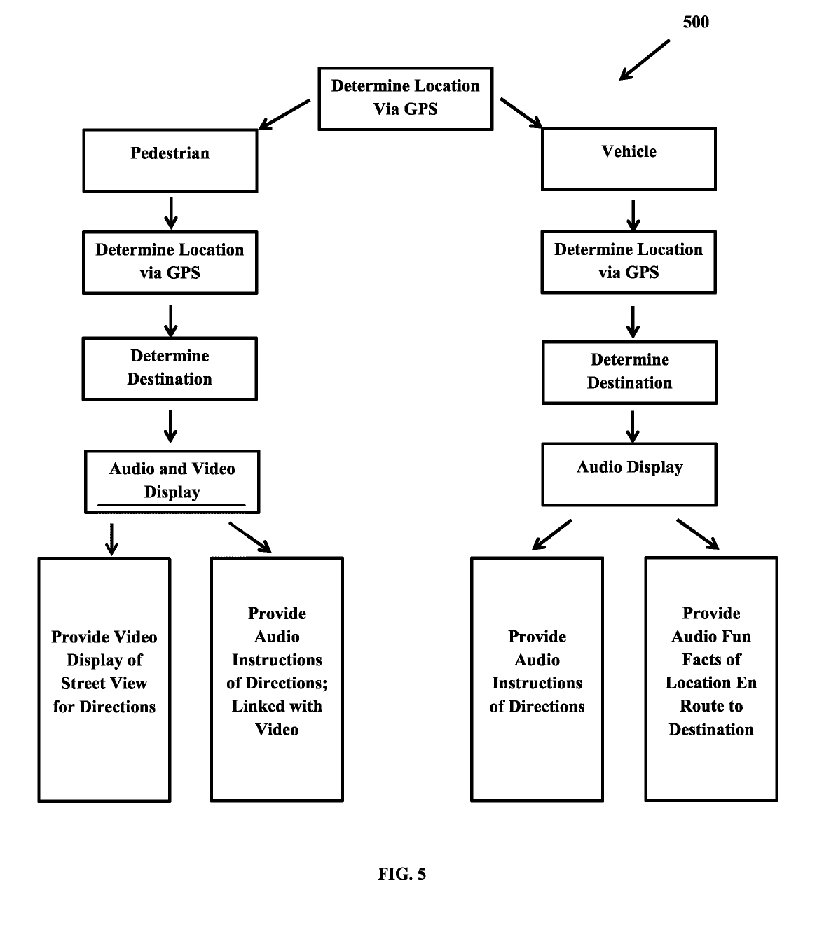

FIG. 5 illustrates a flow chart diagram of an exemplary navigation function of the audiovisual navigation method 500, in accordance with an embodiment of the present invention. In this embodiment, the positioning system 102 is configured to track both a vehicle and a pedestrian. The software application can be set for either by the user. For either situation, the positioning system 102 initially locates the geographical site 112 of the user. In one embodiment, a destination is entered for providing directions. The route and directions may then be displayed. For the pedestrian version, a video and audio instructions for a street or building are provided. The video shows a street view, as if the user was walking through the street. For the vehicle version, audio turn-by-turn directions are provided, along with fun facts about the geographical site 112, including the starting point, the route, and the final destination.

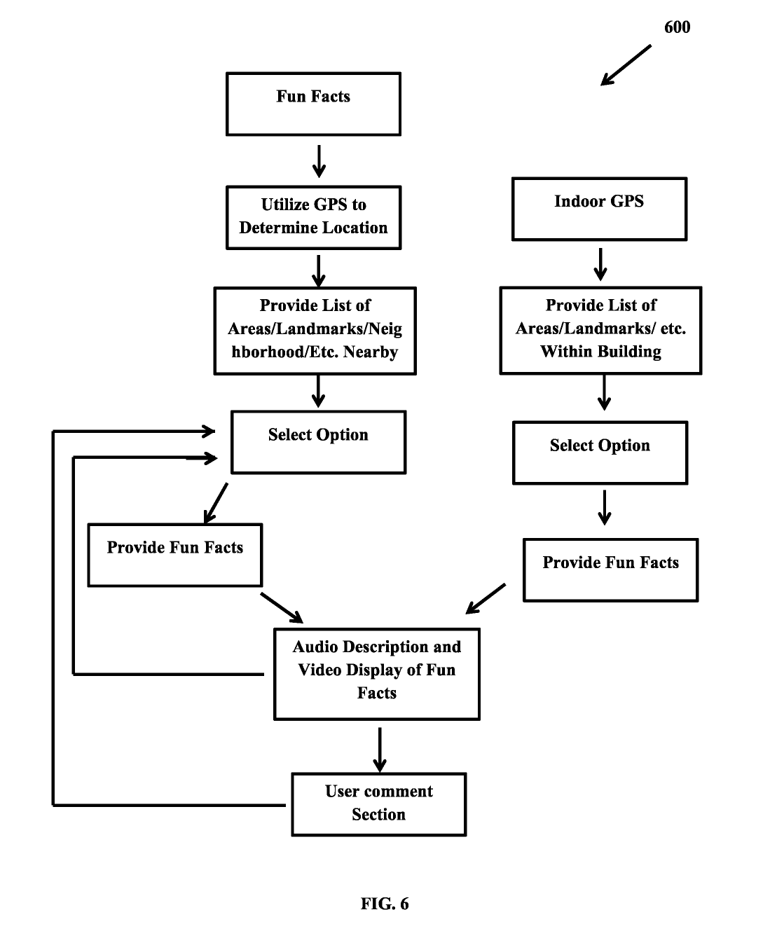

FIG. 6 illustrates a flow chart diagram of an exemplary an audiovisual navigation method 600 displaying audiovisual data 104 in the form of fun facts about a geographical site 112, in accordance with an embodiment of the present invention. The method 600 displays fun facts to the user during the route to the final destination or at the final destination. The audiovisual data 104 displays the fun facts that correlates to the geographical site 112 in the form of audio signals, videos, and images. For example, while passing a castle, a video of how the castle was constructed displays, along with a recommended gift store to purchase castle memorabilia. This graphical depiction of the fun facts creates a more realistic depiction of the location and facilitates the visualization of points of interest. The fun facts version can be used for both indoor regions and outdoor regions.

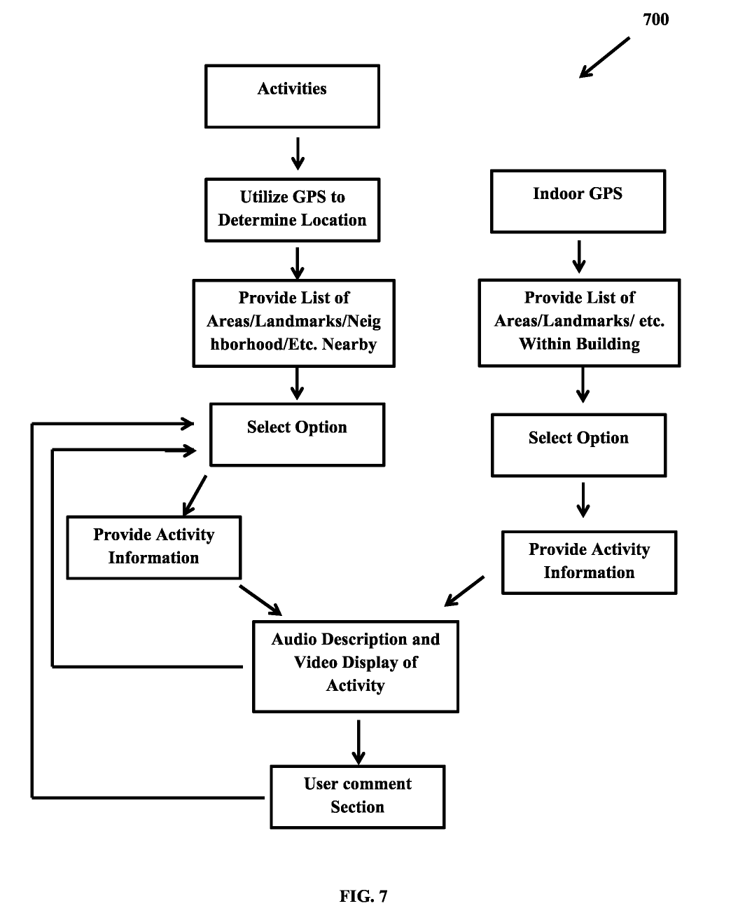

FIG. 7 illustrates a flow chart diagram of an exemplary an audiovisual navigation method 700 displaying audiovisual data 104 in the form of activities for a geographical site 112, in accordance with an embodiment of the present invention. The method 700 provides possible activities on the route or final destination to present to the user. Audiovisual data 104 displays the activities that correlates to the geographical site 112 in the form of audio signals, videos, and images. For example, while passing a swimming pool, a swimming instructional video displays, along with a commercial for a recommended swimsuit and swimming pool accessory retail store in the area. This graphical depiction of the activities creates a more realistic depiction of the location and facilitates the visualization of points of interest. The activities version can be used for both indoor regions and outdoor regions.

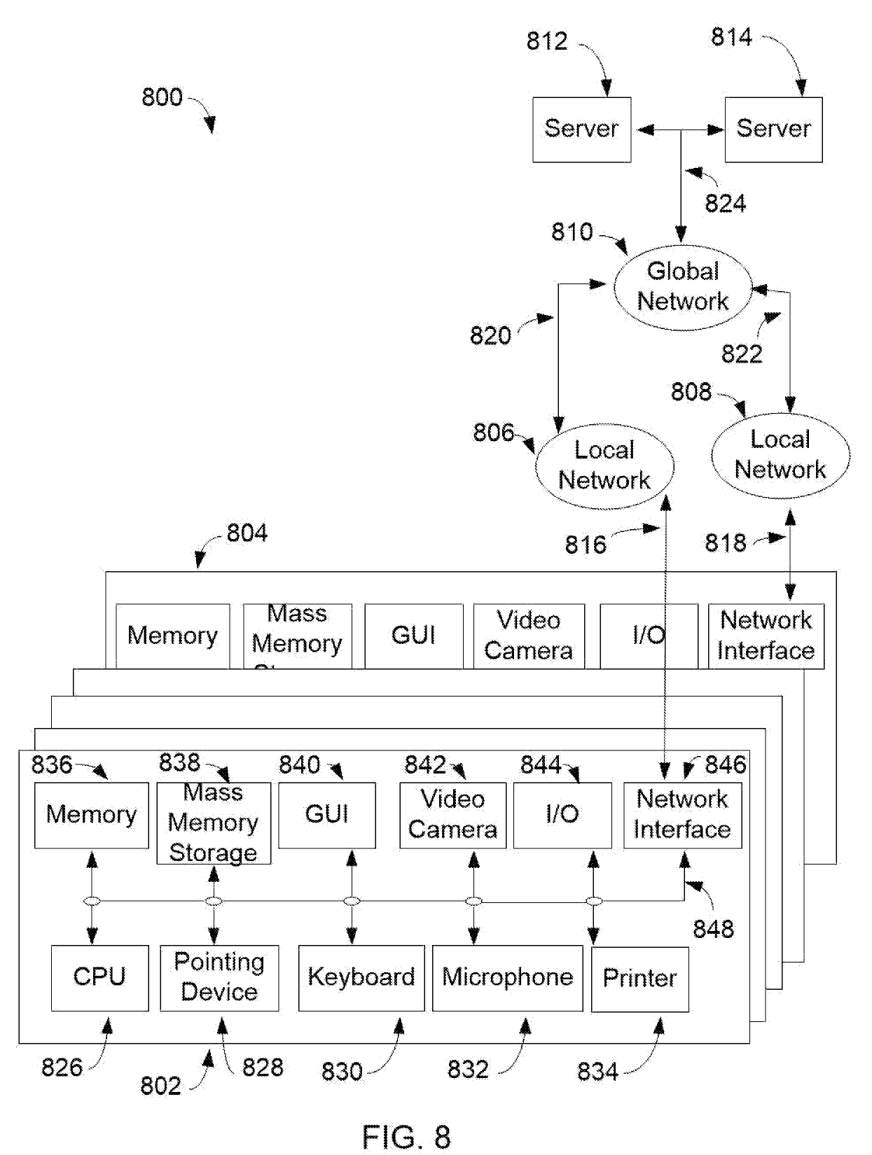

FIG. 8 is a block diagram depicting an exemplary client/server system which may be used by an exemplary web-enabled/networked embodiment of the present invention. In one embodiment, a communication system 800 includes a multiplicity of clients with a sampling of clients denoted as a client 802 and a client 804, a multiplicity of local networks with a sampling of networks denoted as a local network 806 and a local network 808, a global network 810 and a multiplicity of servers with a sampling of servers denoted as a server 812 and a server 814.

Client 802 may communicate bi-directionally with local network 806 via a communication channel 816. Client 804 may communicate bi-directionally with local network 808 via a communication channel 818. Local network 806 may communicate bi-directionally with global network 810 via a communication channel 820. Local network 808 may communicate bi-directionally with global network 810 via a communication channel 822. Global network 810 may communicate bi-directionally with server 812 and server 814 via a communication channel 824. Server 812 and server 814 may communicate bi-directionally with each other via communication channel 824. Furthermore, clients 802, 804, local networks 806, 808, global network 810 and servers 812, 814 may each communicate bi-directionally with each other.

In one embodiment, global network 810 may operate as the Internet. It will be understood by those skilled in the art that communication system 800 may take many different forms. Non-limiting examples of forms for communication system 800 include local area networks (LANs), wide area networks (WANs), wired telephone networks, wireless networks, or any other network supporting data communication between respective entities.

Clients 802 and 804 may take many different forms. Non-limiting examples of clients 802 and 804 include personal computers, personal digital assistants (PDAs), cellular phones and smartphones.

Client 802 includes a CPU 826, a pointing device 828, a keyboard 830, a microphone 832, a printer 834, a memory 836, a mass memory storage 838, a GUI 840, a video camera 842, an input/output interface 844 and a network interface 846.

CPU 826, pointing device 828, keyboard 830, microphone 832, printer 834, memory 836, mass memory storage 838, GUI 840, video camera 842, input/output interface 844 and network interface 846 may communicate in a unidirectional manner or a bi-directional manner with each other via a communication channel 848. Communication channel 848 may be configured as a single communication channel or a multiplicity of communication channels.

CPU 826 may be comprised of a single processor or multiple processors. CPU 826 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 836 is used typically to transfer data and instructions to CPU 826 in a bi-directional manner. Memory 836, as discussed previously, may include any suitable computer-readable media, intended for data storage, such as those described above excluding any wired or wireless transmissions unless specifically noted. Mass memory storage 838 may also be coupled bi-directionally to CPU 826 and provides additional data storage capacity and may include any of the computer-readable media described above. Mass memory storage 838 may be used to store programs, data and the like and is typically a secondary storage medium such as a hard disk. It will be appreciated that the information retained within mass memory storage 838, may, in appropriate cases, be incorporated in standard fashion as part of memory 836 as virtual memory.

CPU 826 may be coupled to GUI 840. GUI 840 enables a user to view the operation of computer operating system and software. CPU 826 may be coupled to pointing device 828. Non-limiting examples of pointing device 828 include computer mouse, trackball and touchpad. Pointing device 828 enables a user with the capability to maneuver a computer cursor about the viewing area of GUI 840 and select areas or features in the viewing area of GUI 840. CPU 826 may be coupled to keyboard 830. Keyboard 830 enables a user with the capability to input alphanumeric textual information to CPU 826. CPU 826 may be coupled to microphone 832. Microphone 832 enables audio produced by a user to be recorded, processed and communicated by CPU 826. CPU 826 may be connected to printer 834. Printer 834 enables a user with the capability to print information to a sheet of paper. CPU 826 may be connected to video camera 842. Video camera 842 enables video produced or captured by user to be recorded, processed and communicated by CPU 826.

CPU 826 may also be coupled to input/output interface 844 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 826 optionally may be coupled to network interface 846 which enables communication with an external device such as a database or a computer or telecommunications or internet network using an external connection shown generally as communication channel 816, which may be implemented as a hardwired or wireless communications link using suitable conventional technologies. With such a connection, CPU 826 might receive information from the network, or might output information to a network in the course of performing the method steps described in the teachings of the present invention.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. An audiovisual navigation method for displaying audiovisual data that correlates to a geographic site, the method comprising:
providing a positioning system configured to locate a geographical site;
correlating an audiovisual data to the geographical site;
storing the audiovisual data;
contributing and/or receiving at least a portion of the audiovisual data by at least one member in a network;
locating the geographical site with the positioning system, wherein the geographical site is located in real time;
retrieving the audiovisual data that correlates to the correlating geographical site; and
displaying the audiovisual data that correlates to the geographical site.

2. The method of claim 1, wherein the positioning system comprises a global positioning system.

3. The method of claim 2, wherein the step of providing a positioning system, further comprises providing a positioning system receiver in a mobile device for satellite communication with the positioning system.

4. The method of claim 3, wherein the mobile device comprises a smart phone.

5. The method of claim 4, wherein the method comprises a step of downloading a software application on the mobile device, the software application configured to operate the method.

6. The method of claim 5, wherein the audiovisual data comprises an audio signal, a video, and an image.

7. The method of claim 6, wherein the step of storing an audiovisual data that correlates to a geographical site, further comprises storing the audiovisual data in a database.

8. The method of claim 7, wherein the geographical site comprises an indoor region and/or an outdoor region.

9. The method of claim 8, wherein the step of contributing and/or receiving at least a portion of the audiovisual data by at least one member in a network, further comprises the at least one member contributing at least a portion of the audiovisual data from a known geographical site.

10. The method of claim 9, wherein the known geographical site is at least partially known by the at least one contributing member.

11. The method of claim 10, wherein the step of contributing and/or receiving at least a portion of the audiovisual data by at least one member in a network, further comprises monetizing the contribution and reception of the audiovisual data by charging the at least one member for contributing and/or receiving the audiovisual data.

12. The method of claim 11, wherein the network comprises a social website.

13. The method of claim 12, wherein the step of locating the geographical site through the positioning system, further includes identifying a position and a time for the mobile device.

14. The method of claim 13, wherein the step of displaying the audiovisual data, further comprises displaying the audiovisual data on a mobile device.

15. The method of claim 14, wherein the audiovisual data is configured to display as a narrative.

16. The method of claim 15, wherein the narrative comprises turn-by-turn directions, fun facts, activities, recommendations for commercial businesses, descriptions of historical buildings, and reminders of prior navigated routes.

17. An audiovisual navigation system for displaying audiovisual data that correlates to a geographic site, the system comprising:
a positioning system configured to locate a geographical site of a positioning system receiver;
an audiovisual data configured to correlate to the geographical site,
the audiovisual data further configured to be stored in a database,
the audiovisual data comprising an audio signal, a video, and an image,
at least a portion of the audiovisual data contributed by at least one member in a network; and
a display device configured to retrieve the audiovisual data that correlates to the geographical site from the database,
the display device further configured to display the audiovisual data.

18. The system of claim 17, wherein the system is configured to be downloaded on the display device as a software application.

19. The system of claim 18, wherein the positioning system comprises a global positioning system.

20. The system of claim 19, wherein the audiovisual data comprises an audio signal, a video, and an image.
